(19) United States
(12) Patent Application Publication
(10) Pub. No.: US 2022/0174793 A1
(43) Pub. Date: Jun. 2, 2022

(54) INDUCTION HEATING COOKING APPARATUS

(71) Applicant: Samsung Electronics Co., Ltd., Suwon-si (KR)

(72) Inventors: Sungwook CHO, Suwon-si (KR); Junghye KANG, Suwon-si (KR); Youngtae KIM, Suwon-si (KR); Taehyung KIM, Suwon-si (KR)

(21) Appl. No.: 17/675,867

(22) Filed: Feb. 18, 2022

Related U.S. Application Data
(63) Continuation of application No. PCT/KR2020/010878, filed on Aug. 14, 2020.

(30) Foreign Application Priority Data
Aug. 19, 2019 (KR) 10-2019-0100961

(51) Int. Cl. H05B 6/12; H05B 3/74

(52) U.S. Cl. CPC H05B 6/1209; H05B 3/74

(57) ABSTRACT

An induction heating cooking apparatus includes a glass provided such that a cooking container is disposed on an upper surface thereof and a side surface thereof is exposed to the outside. The induction heating cooking apparatus also includes an operating coil positioned below the glass to inductively heat the cooking container by generating a magnetic field. The side surface includes a first surface extending from the upper surface of the glass and having a first curvature. The side surface also includes a second surface extending from the first surface and having a second curvature different from the first curvature. The side surface further includes a third surface extending from the second surface to a lower surface of the glass and having a third curvature different from the first curvature and the second curvature.

### CROSS-REFERENCE TO RELATED APPLICATIONS

This application is a continuation of International Patent Application No. PCT/KR2020/010878 filed on Aug. 14, 2020, which claims priority to Korean Patent Application No. 10-2019-0100961 filed on Aug. 19, 2019, the disclosures of which are herein incorporated by reference in their entirety.

### BACKGROUND

### 1. Field

The present disclosure relates to an induction heating cooking apparatus, and more particularly, to a cooking apparatus including a glass having an increased strength against impact from a side.

### 2. Description of Related Art

In general, an induction heating cooking apparatus is a cooking apparatus that cooks food by heating a cooking container using the principle of induction heating. The induction heating cooking apparatus may include a glass on which the cooking container is placed, and an induction coil disposed below the glass that generates a magnetic field when a current is applied.

When a current is applied to the induction coil and a magnetic field is generated, a secondary current is induced to a cooking container, and Joule heat is generated by the electrical resistance of the cooking container itself. Accordingly, the cooking container is heated and food contained in the cooking container is cooked.

The induction heating cooking apparatus may provide rapid heating, no harmful gas generation, and no risk of fire, compared to a gas range and a kerosene stove burning fossil fuels such as gas and oil to heat a cooking container through the heat of combustion.

A frame made of a metal material may be provided on an edge of a glass on which a cooking container is placed. The frame may prevent the glass from being damaged when the cooking container directly collides with a side surface of the glass.

When the frame covers an upper edge of the glass, the frame may look like a bezel of a display apparatus. Similar to the preference for bezelless designs in recent display apparatuses, users prefer invisible frames on edges of glasses in induction heating cooking apparatuses.

Therefore, the frame can be removed in order to improve the aesthetics of the induction heating cooking apparatus. However, when the frame is removed, the glass may be damaged when the cooking container collides with a side surface of the glass.

The present disclosure is directed to providing an induction heating cooking apparatus with improved aesthetics by removing a frame covering an edge of a glass.

The present disclosure is directed to providing an induction heating cooking apparatus including a glass having an increased strength against impact from a side.

The present disclosure is directed to providing an induction heating cooking apparatus with reduced production cost and improved marketability by removing a frame for covering a side surface of a glass.

### SUMMARY

An aspect of the present disclosure provides an induction heating cooking apparatus including a glass provided such that a cooking container is disposed on an upper surface thereof and a side surface thereof is exposed to the outside, and an operating coil positioned below the glass to inductively heat the cooking container by generating a magnetic field, wherein the side surface of the glass includes a first surface extending from the upper surface of the glass and having a first curvature, a second surface extending from the first surface and having a second curvature different from the first curvature, and a third surface extending from the second surface to a lower surface of the glass and having a third curvature different from the first curvature and the second curvature.

A radius of curvature of the first surface may be formed to be greater than a radius of curvature of the second surface and a radius of curvature of the third surface.

A height of the first surface may be formed to be greater than the sum of a height of the second surface and a height of the third surface.

A height of the glass may be the sum of a height of the first surface, a height of the second surface, and a height of the third surface.

A radius of curvature of the first surface may be 3.5 mm to 5 mm.

A radius of curvature of the second surface may be 2.0 mm.

A radius of curvature of the third surface may be 0.5 mm.

When the height of the glass is 4 mm, the height of the first surface may be 3.5 mm.

A Rz roughness of the first surface may be 0.5 μm.

The upper surface of the glass may include a corner, and a radius of curvature of the corner may be 12 mm or more.

According to the present disclosure, an induction heating cooking apparatus with improved aesthetics can be provided by removing a frame covering an edge of a glass.

According to the present disclosure, an induction heating cooking apparatus including a glass having an increased strength against impact from a side can be provided.

According to the present disclosure, an induction heating cooking apparatus with reduced production cost and improved marketability can be provided by removing a frame for covering a side surface of a glass.

### BRIEF DESCRIPTION OF THE DRAWINGS

FIG. 1 illustrates a perspective view of an induction heating cooking apparatus according to an embodiment of the present disclosure.

FIG. 2 illustrates the induction heating cooking apparatus installed on a cooking table according to an embodiment of the present disclosure.

FIG. 3 illustrates a plan view separately illustrating a glass in the induction heating cooking apparatus according to an embodiment of the present disclosure.

FIG. 4 illustrates a cross-sectional view of the glass taken along line A-A′ in FIG. 3 according to an embodiment of the present disclosure.

FIG. 5 illustrates a graph describing a radius of curvature on a first surface and an impact strength of a side surface of the glass with respect thereto in the induction heating cooking apparatus according to an embodiment of the present disclosure.

FIG. 6 illustrates a table describing the radius of curvature on the first surface and the impact strength of the side surface of the glass with respect thereto in the induction heating cooking apparatus according to an embodiment of the present disclosure.

FIG. 7 illustrates an enlarged view of part B in FIG. 3 according to an embodiment of the present disclosure.

### DETAILED DESCRIPTION

Configurations shown in the embodiments and the drawings described in the present specification are only the preferred embodiments of the present disclosure, and thus it is to be understood that various modified examples, which may replace the embodiments and the drawings described in the present specification, are possible when filing the present application.

The terms used herein are for the purpose of describing the embodiments and are not intended to restrict and/or to limit the disclosure. For example, the singular expressions herein may include plural expressions, unless the context clearly dictates otherwise. Also, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that although the terms first, second, etc. may be used herein to describe various components, these components should not be limited by these terms, and the terms are only used to distinguish one component from another. For example, without departing from the scope of the disclosure, the first component may be referred to as a second component, and similarly, the second component may also be referred to as a first component.

The terms “front end,” “rear end,” “upper portion,” “lower portion,” “upper end” and “lower end” used in the following description are defined with reference to the drawings, and the shape and position of each component are not limited by these terms.

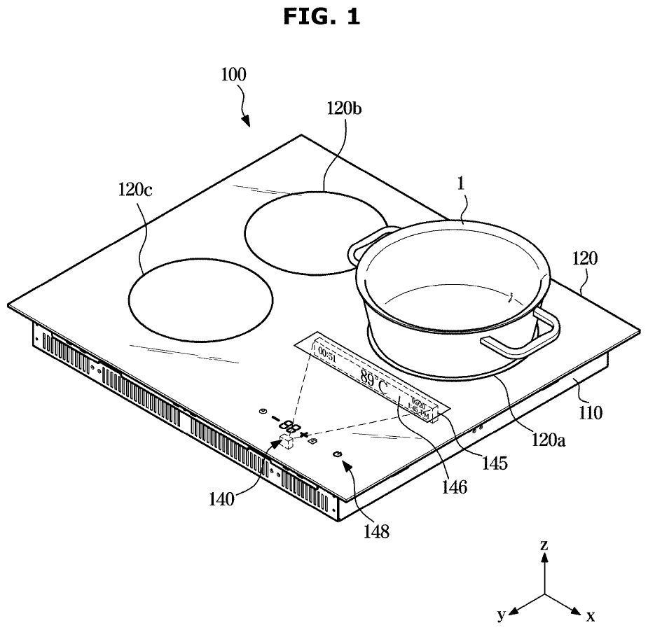

FIG. 1 illustrates a perspective view of an induction heating cooking apparatus according to an embodiment of the present disclosure.

Referring to FIG. 1, an induction heating cooking apparatus 100 may include a main body 110 forming an exterior, a glass 120 made of a heat-resistant material positioned above the main body 110, including heating area guides 120a, 120b, and 120c, and provided to support a cooking container 1, and an operating coil (not shown) provided to generate a magnetic field for inductively heating the cooking container 1.

The induction heating cooking apparatus 100 may also include a reflector 145 (image forming plate such as a projection plate and a screen, hereinafter referred to as the reflector) and a projection unit 140 provided to output the cooking information 146 (or including operation state information) to the reflector 145.

Food ingredients contained in the cooking container 1 may be cooked by induction heating by the magnetic field generated by the operating coil. The cooking information 146 of the induction heating cooking apparatus 100 including the temperature of the cooking container 1, the elapsed cooking time and/or the date/time may be output from the projection unit 140 to the reflector 145 spaced apart in an optical axis direction. A user may check the cooking information 146 of the induction heating cooking apparatus 100 reflected from the reflector 145 through the glass 120.

According to an embodiment of the present disclosure, display on the cooking information of the induction heating cooking apparatus 100 reflected from the reflector 145 may include display of cooking information, partial display of cooking information and operation state information, and display of cooking information and operation state information.

An operation and/or function of the induction heating cooking apparatus 100 may be controlled using an operation panel 148 of the induction heating cooking apparatus 100 corresponding to a touch of the glass 120 of the user (or non-contact including hovering). The user may control the operation and/or function of the induction heating cooking apparatus 100 using the operation panel 148 of the induction heating cooking apparatus 100 positioned below the glass 120.

The induction heating cooking apparatus 100 may include the main body 110 and the glass 120. The main body 110 may accommodate a plurality of the operating coils (not shown) therein.

An upper side of the main body 110 may be opened. The glass 120 made of a heat-resistant material may be positioned on the open upper side of the main body 110. The glass 120 may be positioned to cover the open upper side of the main body 110.

The glass 120 may include a heat-resistant transparent glass or a heat-resistant transparent tempered glass. An area of the glass 120 may be provided to be larger than an area of the open upper side of the main body 110. For example, the area of the glass 120 may be smaller than 150% of the area of the open upper side of the main body 110.

The glass 120 may be painted black or another color. Specifically, one surface of the glass 120 may be painted black or another color. For example, a lower surface of the glass 120 may be painted black or another color. Alternatively, the glass 120 may be provided such that one surface thereof is divided into a plurality of areas, and the divided areas may be painted in various colors.

When the lower surface of the glass 120 is painted black or another color, the user may recognize the cooking information of the induction heating cooking apparatus 100 reflected from the reflector 145. Components located inside the main body 110 of the induction heating cooking apparatus 100 may not be identified from the outside by the painting of the glass 120. In addition, a portion of the glass 120 may be painted black.

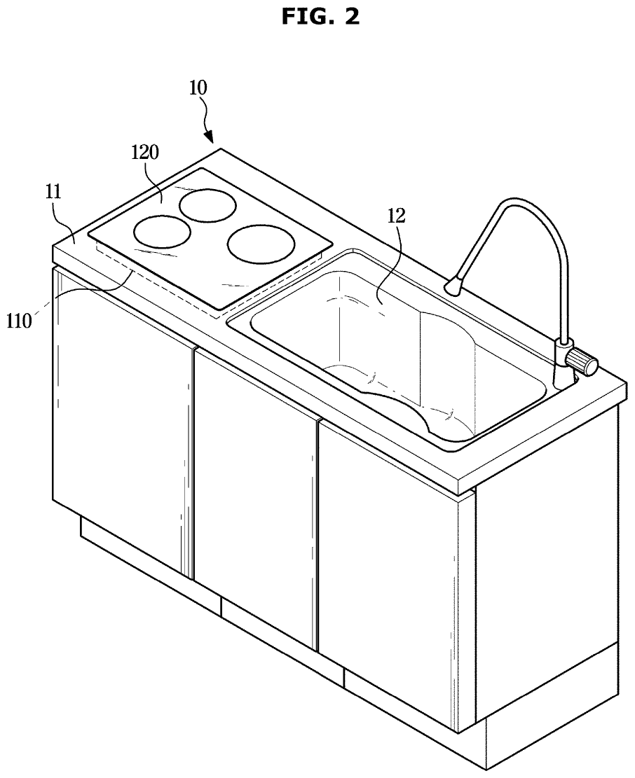

FIG. 2 illustrates the induction heating cooking apparatus installed on a cooking table according to an embodiment of the present disclosure.

Referring to FIG. 2, the induction heating cooking apparatus 100 according to an embodiment of the present disclosure may be installed on a cooking table 10. The cooking table 10 is a space provided to perform cooking, and as illustrated in the drawing, a sink 12 may be provided on one side of the cooking table 10. This is an example, and the induction heating cooking apparatus 100 according to an embodiment of the present disclosure may be installed on various types of the cooking tables 10.

A groove into which the main body 110 of the induction heating cooking apparatus 100 is inserted may be provided on the cooking table 10. Although not specifically illustrated in the drawing, the groove may be formed by recessing a portion of an upper surface 11 of the cooking table 10 to the inside of the cooking table 10. The groove may be provided to be larger than the main body 110 to accommodate the main body 110, and may be provided to be smaller than the glass 120 to prevent the glass 120 from being inserted into the groove.

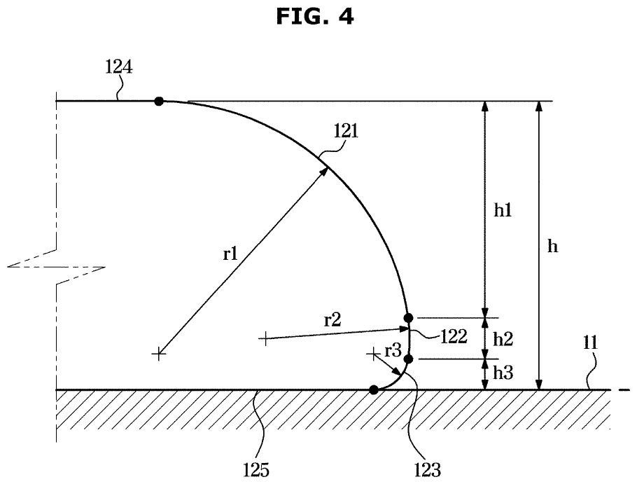

The reason that the glass 120 is provided to be larger than the groove is to prevent foreign substances such as food generated during cooking from entering through a gap provided between the glass 120 and the groove. The glass 120 may be seated on the upper surface 11 of the cooking table 10. A lower surface 125 (see FIG. 4) of the glass 120 may be disposed to be in contact with the upper surface 11 of the cooking table 10.

When the glass 120 is disposed on the upper surface 11 of the cooking table 10, a side surface of the glass 120 may be exposed to the upper side of the cooking table 10. When the side surface of the glass 120 is not structured to be inserted into the groove formed in the cooking table 10, the side surface of the glass 120 is positioned above the upper surface 11 of the cooking table 10. According to this arrangement, a case may occur in which the cooking container 1 and the side surface of the glass 120 come into contact with each other while the user uses the cooking container 1.

According to the present disclosure, a frame made of a metal material may not be provided on a side edge of the glass 120. Embodiments of the present disclosure take into consideration that the cooking container 1 may directly collide with the side surface of the glass 120 such as when in a process in which the user moves the cooking container 1. In a case where an impact strength of the side surface of the glass 120 is weak, the glass 120 may be damaged when the cooking container 1 collides with the side surface of the glass 120. Because the glass 120 is not easy to replace and the replacement cost is high, embodiments of the present disclosure take into consideration that it is important to prevent the glass 120 from being damaged. According to the present disclosure, an induction heating cooking apparatus that does not include a frame for covering a side surface of a glass and may prevent the glass from being damaged even when a cooking container directly collides with the side surface of the glass by improving the impact strength of the side surface of the glass may be provided.

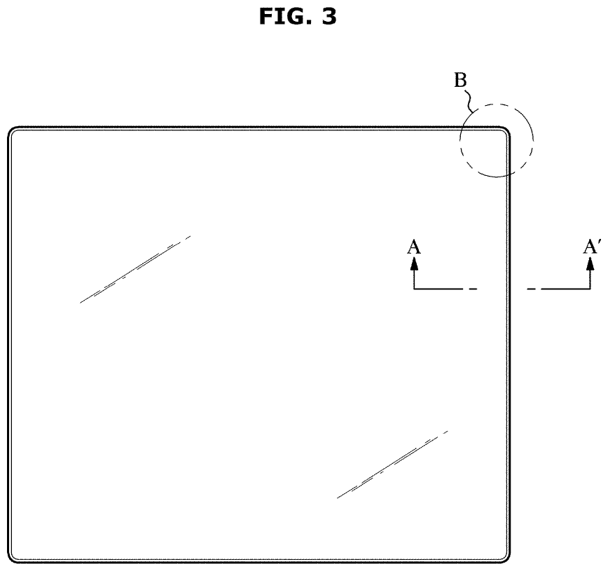

FIG. 3 illustrates a plan view separately illustrating a glass in the induction heating cooking apparatus according to an embodiment of the present disclosure.

Referring to FIG. 3, in the induction heating cooking apparatus according to an embodiment of the present disclosure, the glass 120 may be provided as a thin rectangular plate. As described above, the glass 120 may be provided with a heat-resistant material.

The glass 120 may have a length in a horizontal direction (x-axis direction in FIG. 1) longer than a length in a vertical direction (y-axis direction in FIG. 1), but is not limited thereto. The glass 120 may be provided in a square shape in which the length in the horizontal direction is equal to the length in the vertical direction, or may be provided such that the length in the vertical direction is longer than the length in the horizontal direction.

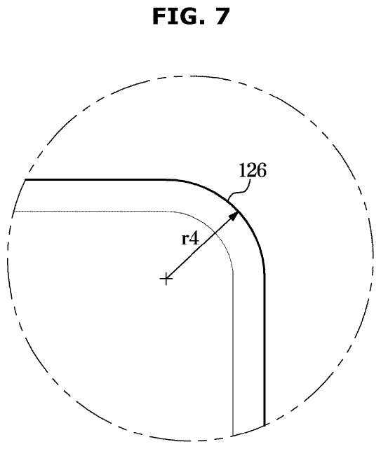

The glass 120 may be formed to have a rounded corner 126 (see FIG. 7). In certain embodiments, each of four corners of the glass 120 may be formed to have a curvature similar to the rounded corner 126. Because the corner 126 of the glass 120 is formed to be round, it may be prevented in advance that the user is injured due to the corner 126 of the glass 120.

As illustrated in FIG. 3, the induction heating cooking apparatus according to the present disclosure may not include a frame provided to cover an edge of the glass 120.

Conventionally, in order to prevent damage of the glass, a frame made of a metal material is provided to surround the edge of the glass. The frame prevents the glass from being damaged by direct collision of the cooking container with the glass, and the frame is provided to surround the upper surface of the glass as well as the side surface of the glass. However, such the frame may reduce the unity of a design of the glass.

The induction heating cooking apparatus 100 according to the present disclosure may not include a frame for covering a portion of the side and upper surfaces of the glass 120 in order to implement the unity of the design of the glass 120.

FIG. 4 illustrates a cross-sectional view of the glass taken along line A-A′ in FIG. 3 according to an embodiment of the present disclosure.

Referring to FIG. 4, the side surface of the glass 120 according to an embodiment of the present disclosure may include a first surface 121 having a first curvature, a second surface 122 having a second curvature, and a third surface 123 having a third curvature.

Hereinafter, having a curvature may be used as the same meaning as being formed in an arc shape having a radius of curvature.

The first surface 121 may be connected to an upper surface 124 of the glass 120. Specifically, one end of the first surface 121 may be connected to the upper surface 124 of the glass, and the other end of the first surface 121 may be connected to the second surface 122.

One end of the second surface 122 may be connected to the first surface 121, and the other end of the second surface 122 may be connected to the third surface 123.

One end of the third surface 123 may be connected to the second surface 122, and the other end of the third surface 123 may be connected to the lower surface 125 of the glass.

The first surface 121 may be formed in a circular arc having a radius of curvature of r1, the second surface 122 may be formed as an arc having a radius of curvature of r2, and the third surface 123 may be formed as an arc having a radius of curvature of r3. In this case, r1 to r3 may satisfy the following condition.

r1>r2>r3

Hereinafter, the length in the vertical direction (z-axis direction in FIG. 1) of the glass 120 is referred to as a height h of the glass 120. Specifically, the length in the vertical direction between the upper surface 124 and the lower surface 125 of the glass 120 is referred to as the height h of the glass 120.

According to an embodiment of the present disclosure, the first surface 121 may have a first height h1, the second surface 122 may have a second height h2, and the third surface 123 may have a third height h3. The sum of the first height h1 to the third height h3 is equal to the height h of the glass 120. Therefore, h1 to h3 may satisfy the following condition.

h=h1+h2+h3

According to an embodiment of the present disclosure, the first height h1 may be provided to be greater than the second height h2. Furthermore, the first height h1 may be provided to be greater than the sum of the second height h2 and the third height h3. Therefore, h1 to h3 may satisfy the following condition.

h1>h2+h3

Also, according to an embodiment of the present disclosure, the second height h2 and the third height h3 may be provided to be the same. Therefore, h2 and h3 may satisfy the following condition.

h2=h3

According to an embodiment of the present disclosure, the height h of the glass 120 may be 4.0 mm. The first height h1 of the first surface 121 may be 3.5 mm. In addition, the second height h2 of the second surface 122 and the third height h3 of the third surface 123 may be 0.5 mm, respectively.

According to the present disclosure, as the side surface of the glass 120 is composed of the first surface 121 to the third surface 123 as described above, even when the cooking container 1 collides with the side surface of the glass 120, the cooking container 1 may be smoothly seated on the upper surface of the glass 120 along the surface side of the glass 120. In addition, according to the present disclosure, as the impact strength of the side surface of the glass 120 increases, the glass 120 may be prevented from being damaged even when the cooking container 1 directly collides with the side surface of the glass 120.

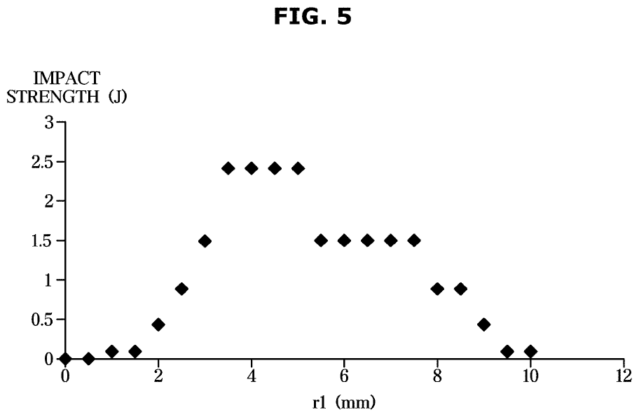

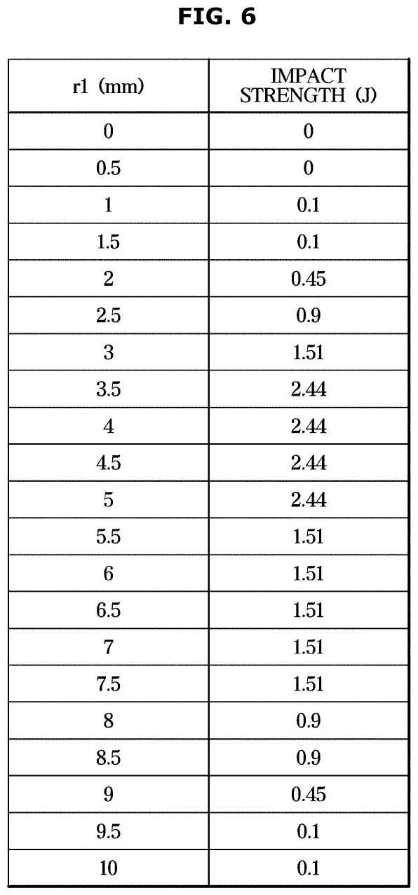

FIG. 5 illustrates a graph describing a radius of curvature on a first surface and an impact strength of a side surface of the glass with respect thereto in the induction heating cooking apparatus according to an embodiment of the present disclosure. FIG. 6 illustrates a table describing the radius of curvature on the first surface and the impact strength of the side surface of the glass with respect thereto in the induction heating cooking apparatus according to an embodiment of the present disclosure.

Referring to FIGS. 5 and 6, in the induction heating cooking apparatus according to an embodiment of the present disclosure, it may be seen that the impact strength of the side surface of the glass 120 changes depending on a change in the radius of curvature r1 of the first surface 121 of the glass 120. Specifically, FIGS. 5 and 6 illustrate a change in the impact strength of the first surface 121 depending on a change in the radius of curvature r1 of the first surface 121.

The reason for illustrating the impact strength of the first surface 121 is that the cooking container 1, when colliding with the side surface of the glass 120, generally comes into contact with the first surface 121 instead of the second surface 122 or the third surface 123. Accordingly when the cooking container 1 collides with the side surface of the glass 120 such as when the user moves the cooking container 1 laterally, it is important to increase the impact strength of the first surface 121.

In order to increase the impact strength of the first surface 121, the size of the radius of curvature r1 of the first surface 121 is 3.5 mm to 5 mm. Referring to FIGS. 5 and 6, it may be seen that the impact strength when r1 is 3 mm is 1.51 J, while the impact strength when r1 is 3.5 mm is 2.44 J, indicating that the impact strength changes steeply. In addition, it may be seen that the impact strength when r1 is 5.5 mm is also 1.51 J, while the impact strength when r1 is 5 mm is 2.44 J, indicating that the impact strength changes steeply. In addition, it may be seen that when r1 is 3.5 mm to 5 mm, the impact strength is constant at 2.44 J. As a result, the impact strength is increased when r1 is 3.5 mm to 5 mm, and it may be considered to have critical significance.

In addition, although not shown in the drawings, according to an embodiment of the present disclosure, a Rz roughness of the first surface 121 of the glass 120 may be 0.5 μm. This is to increase the impact strength of the first surface 121. According to the experimental data, when the Rz roughness of the first surface 121 is 0.5 μm, the impact strength of the first surface 121 increases to 3.15 J. On the other hand, when the Rz roughness of the first surface 121 is 1.0 μm, the impact strength of the first surface 121 is 2.44 J. Therefore, it may be seen that the impact strength of the first surface 121 increases by changing the Rz roughness, and in particular, it may be seen that the impact strength of the first surface 121 increases when the Rz roughness is 0.5 μm. Therefore, according to an embodiment of the present disclosure, it is appropriate that the Rz roughness of the first surface 121 is 0.5 μm.

According to an embodiment of the present disclosure, r1 may be 3.5 mm. r2 may be 2.0 mm, and r3 may be 0.5 mm. In addition, the Rz roughness on the first surface 121 may be 0.5 μm. According to these conditions, in the glass 120 according to an embodiment of the present disclosure, the impact strength of the side surface may be 3.15 J. In addition, even when the impact of 3.15 J is applied 146 times, the glass 120 may not be damaged.

FIG. 7 illustrates an enlarged view of part B in FIG. 3 according to an embodiment of the present disclosure.

According to an embodiment of the present disclosure, when the glass 120 is viewed above the upper surface thereof, the corner 126 of the glass 120 may be formed to be rounded. Specifically, the corner 126 of the glass 120 may be formed in an arc shape having a radius of curvature of r4.

In this case, it is appropriate that r4 is 12 mm or more. Although not shown in the drawing, when r4 is less than 12 mm, the impact strength of the glass corner is 0.19 J, which is relatively low, and the corner of the glass 120 may be damaged immediately when such an impact is applied.

On the other hand, when r4 is 12 mm or more, the impact strength of the glass corner increases to 0.45 J. It is noted that even when such an impact is applied 20 times or more, the corner of the glass 120 may not be damaged.

Therefore, according to an embodiment of the present disclosure, it is appropriate that the radius of curvature r4 of the corner 126 of the glass 120 is 12 mm or more.

Although the present disclosure has been described with various embodiments, various changes and modifications may be suggested to one skilled in the art. It is intended that the present disclosure encompass such changes and modifications as fall within the scope of the appended claims.

What is claimed is:

1. An induction heating cooking apparatus comprising:
a glass including an upper surface and a side surface, wherein the upper surface supports a cooking container that is disposed thereon and the side surface is externally exposed; and
an operating coil positioned below the glass to inductively heat the cooking container by generating a magnetic field,
wherein the side surface of the glass comprises:
a first surface extending from the upper surface of the glass and including a first curvature;
a second surface extending from the first surface and including a second curvature different from the first curvature; and
a third surface extending from the second surface to a lower surface of the glass and including a third curvature different from the first curvature and the second curvature.

2. The induction heating cooking apparatus of claim 1, wherein:
a radius of curvature of the first surface is formed to be greater than a radius of curvature of the second surface and a radius of curvature of the third surface.

3. The induction heating cooking apparatus of claim 1, wherein:
a height of the first surface is formed to be greater than a sum of a height of the second surface and a height of the third surface.

4. The induction heating cooking apparatus of claim 1, wherein:
a height of the glass is based on a height of the first surface, a height of the second surface, and a height of the third surface.

5. The induction heating cooking apparatus of claim 1, wherein:
a radius of curvature of the first surface is 3.5 mm to 5 mm.

6. The induction heating cooking apparatus of claim 1, wherein:
a radius of curvature of the second surface is 2.0 mm.

7. The induction heating cooking apparatus according to claim 1, wherein:
a radius of curvature of the third surface is 0.5 mm.

8. The induction heating cooking apparatus of claim 4, wherein:
when the height of the glass is 4 mm, the height of the first surface is 3.5 mm.

9. The induction heating cooking apparatus according to claim 1, wherein:
a Rz roughness of the first surface is 0.5 μm.

10. The induction heating cooking apparatus of claim 1, wherein:
the upper surface of the glass comprises a corner, and a radius of curvature of the corner is 12 mm or more.

11. A glass comprising:
an upper surface configured to support a cooking container thereon;
a lower surface opposite the upper surface; and
a side surface that is externally exposed connecting the upper and lower surfaces, wherein the side surface comprises:
a first surface extending from the upper surface and including a first curvature,
a second surface extending from the first surface and including a second curvature different from the first curvature, and
a third surface extending from the second surface to the lower surface of the glass and including a third curvature different from the first curvature and the second curvature.

12. The glass of claim 11, wherein:
a radius of curvature of the first surface is formed to be greater than a radius of curvature of the second surface and a radius of curvature of the third surface.

13. The glass of claim 11, wherein:
a height of the first surface is formed to be greater than a sum of a height of the second surface and a height of the third surface.

14. The glass of claim 11, wherein:
a height of the glass is based on a height of the first surface, a height of the second surface, and a height of the third surface.

15. The glass of claim 11, wherein:
a radius of curvature of the first surface is 3.5 mm to 5 mm.

16. The glass of claim 11, wherein:
a radius of curvature of the second surface is 2.0 mm.

17. The glass of claim 11, wherein:
a radius of curvature of the third surface is 0.5 mm.

18. The glass of claim 14, wherein:
when the height of the glass is 4 mm, the height of the first surface is 3.5 mm.

19. The glass of claim 11, wherein:
a Rz roughness of the first surface is 0.5 μm.

20. The glass of claim 11, wherein:
the upper surface of the glass comprises a corner, and a radius of curvature of the corner is 12 mm or more.
